(19) United States
(12) Patent Application Publication
(10) Pub. No.: US 2021/0291205 A1
(43) Pub. Date: Sep. 23, 2021

(54) SPRAY HEAD FOR A FLUID PRODUCT AND USE OF SUCH A HEAD

(71) Applicant: APTAR FRANCE SAS, LE NEUBOURG (FR)

(72) Inventor: Stéphane BERANGER, SURTAUVILLE (FR)

(73) Assignee: APTAR FRANCE SAS, LE NEUBOURG (FR)

(21) Appl. No.: 16/482,784

(22) PCT Filed: Feb. 13, 2018
(86) PCT No.: PCT/FR2018/050348

§ 371 Date: Aug. 1, 2019

(30) Foreign Application Priority Data
Feb. 9, 2017 (FR) 1751091

(51) Int. Cl. B05B 1/34

(52) U.S. Cl. CPC B05B 1/3436; B65D 83/20

(57) ABSTRACT

A fluid spray head comprising:
a body (1) forming a housing (14) in which there extends a core (16);
a nozzle (2) engaged in the housing (14) around the core (16), and forming a spray orifice (0) presenting a chamber outlet diameter D3 and a chamber outlet section S3;
the core (16) and the nozzle (2) defining between them, from upstream to downstream:
a plurality of swirl channels (T) presenting a channel length L1; and
a swirl chamber (C) presenting a chamber inlet diameter D2, and a chamber inlet section S2, the dispenser orifice (O) forming an outlet for the swirl chamber (C);
the spray head being characterized in that 30% of S2≤S3≤55% of S2, and preferably S3 is equal to approximately 42% of S2.

The present invention relates to a fluid spray head that includes a body that forms a housing in which there extends a core. The head also includes a nozzle that is engaged in the housing around the core so as to form between them a plurality of swirl channels, and a swirl chamber into which the swirl channels open out. The nozzle also includes a dispenser orifice that forms the outlet of the swirl chamber. Such a spray head design is entirely conventional in the fields of cosmetics, perfumery, and pharmacy. The spray head is generally mounted on the free end of the valve rod of a pump or a valve. In general, the spray head forms a pushbutton on which the user can press axially by means of a finger, typically the index finger.

In the prior art, there exist all kinds of fluid spray heads with various characteristics, in particular associated with the configuration, the orientation, the formation, and the proportions of the swirl channels, of the swirl chamber, and of the dispenser orifice, so as to achieve various objectives, such as easy mounting, easy molding, a particular type of spray, a long or short spray, etc. The object of the present invention is to make swirl channels, a swirl chamber, and a spray orifice that serve to obtain a spray of good quality for fluids of a particular type, namely shear thinning fluids. However, the spray head of the present invention may also be used with other types of fluid, while still obtaining a spray of quality that is acceptable or even good.

For a fluid, “shear thinning” means “becoming more fluid” when its speed of flow increases. More precisely, this means that its dynamic viscosity decreases when the shear rate increases. Another term used is “pseudoplasticity”. Shear thinning should not be confused with thixotropy, which refers to the decrease in viscosity under the effect of shear stress.

The behavior of a fluid is shear thinning or pseudoplastic” (old term that is sometimes used) in the shear thinning range, which is situated after the first Newtonian plateau. The viscosity of the fluid decreases (shear thinning) with an increase in the speed gradient. The structure of the substance is oriented/deformed by shear (example: chains of a polymer become aligned along the strain direction). At high shear rates (corresponding to the second Newtonian plateau), the substance is destructured. A structure that does not flow requires more force in order to be destructured. Most samples containing items that are large compared to the atomic scale are shear thinning. The majority (approximately 90%) of substances are shear thinning: polymers, lightly filled (dilute) emulsions, suspensions, shampoos, etc.

The needs of the cosmetic market require the use of formulations that are more and more viscous in order to guarantee their stability. This viscosity reaches a critical limit for being sucked up with conventional manual pumps. Xanthan gum or gel has been identified as a novel base for resolving this problem. This liquid is an excellent stabilizer, has low viscosity, and presents shear thinning characteristics.

In order to obtain a spray, it is necessary to optimize the flow sections of the nozzle so that the speed of the fluid is as fast as possible, so as to make it possible to generate fine droplets at the nozzle outlet.

Thus, an object of the present invention is to optimize the characteristics of the swirl channels, the swirl chamber, and/or the dispenser orifice, so as to obtain a spray that is uniform and balanced, both in three dimensional space and in terms of droplet size. With regard to the shape of the spray, the minimum angle of the spray should be greater than 30°. At a distance of 20 centimeters (cm), the droplets should be spread out enough to avoid running or streaking.

To achieve this object, the present invention proposes a fluid spray head comprising:
a body forming a connection sleeve that is adapted to receive a valve rod of a dispenser member, such as a pump or a valve, the connection sleeve being connected, via a feed duct, to a housing in which there extends a core that defines a core side wall and a core front wall;
a nozzle engaged in the housing around the core, the nozzle forming a spray orifice through which the fluid leaves the spray head in the form of a spray, the spray orifice presenting a chamber outlet diameter D3 and a chamber outlet section S3;
the core and the nozzle defining between them, from upstream to downstream:
   a plurality of connection passages in fluid communication with the feed duct;
   a plurality of swirl channels respectively connected to the connection passages, each swirl channel presenting a channel length L1, a channel inlet having a channel inlet section S0, and a channel outlet having a channel outlet section S1; and
   a swirl chamber into which the swirl channels open out, the swirl chamber defining a longitudinal axis of revolution X and presenting an axial length L2, a chamber inlet diameter D2, and a chamber inlet section S2 where the swirl channels open out, the dispenser orifice forming an outlet for the swirl chamber;

the spray head being characterized in that 30% of S2≤S3≤55% of S2, and preferably S3 is equal to approximately 42% of S2, such that 54% of D2≤D3≤74% of D2, and preferably D3 is equal to approximately 65% of D2, and in that L1≥110% of D2, and preferably L1 is equal to approximately 150% of D2.

Compared to a conventional nozzle that is adapted to spraying alcohol solutions, the outlet section S3 of the dispenser orifice is considerably larger. This is explained by the fact that xanthan gel possesses elastic properties: when it is stressed, it absorbs energy, and it “expands” when it is released. This is what happens while passing through the dispenser orifice of conventional nozzles (=0.3 millimeters (mm) in diameter. During this “expansion”, the droplets that are being formed join together so as to form a jet. In addition, it should also be observed that the length of the swirl channels L1 should also be correlated with the diameter of the swirl chamber, which is itself correlated with the diameter of the dispenser orifice.

Advantageously: 0.2 square millimeters (mm²)≤S3≤0.38 mm², and preferably S3 is equal to approximately 0.33 mm², such that 0.5 mm≤D3≤0.7 mm, and preferably D3 is equal to approximately 0.65 mm. In addition: 0.5 mm²≤S2≤1.13 mm², and preferably S2 is equal to approximately 0.785 mm², such that 0.8 mm≤D2≤1.2 mm, and preferably D2 is equal to approximately 1 mm. Finally, L1≥1.1 mm, and preferably L1 is equal to approximately 1.5 mm.

According to another advantageous characteristic of the invention, the dispenser orifice may be cylindrical and presents an axial length L3 that is less than approximately 30% of D3. It is thus possible for the dispenser orifice to be formed by an annular edge, such that L3 is zero.

According to another advantageous characteristic of the invention: L2≥80% of D2, and preferably L2 is equal to approximately 0.88 mm. In an advantageous embodiment, the swirl chamber includes a frustoconical portion having a maximum diameter that is equal to D2 and that presents an axial length L23 that lies in the range 30% to 60% of D2, and preferably is approximately half of D2. Preferably, the swirl chamber also includes a cylindrical portion into which the swirl channels open out, the cylindrical portion presenting an axial length L22 that is equal to approximately 40% of D2. Thus, from upstream to downstream, the swirl chamber defines firstly a cylindrical portion of diameter D2, and then a frustoconical portion where the diameter goes from D2 to D3.

Without going beyond the ambit of the invention, it is also possible to make a swirl chamber that does not include a frustoconical portion. The swirl chamber is then constituted merely by a cylindrical portion that is connected to the dispenser orifice via a shoulder.

With regard to the swirl channels, S1≤50% of S0, and preferably S1=33% of S0. Advantageously, S1 is equal to approximately 0.07 mm² and S0 is equal to approximately 0.21 mm². This means that the channels have an overall configuration that is triangular to a greater or lesser extent, with a large inlet and a small outlet.

When the outlets of the swirl channels are compared with the swirl chamber, the following relationship is obtained: S1≤10% of S2.

In another advantageous aspect of the invention, the channel inlet forms a rounded wall. This enables the fluid that flows through the connection passages to be deflected into the swirl channels by sliding along the rounded wall, in such a manner as to reduce disturbances and to preserve, as much as possible, a flow that is laminar. The rounded wall finds a very particular advantage with shear thinning fluids that are sensitive to large head losses and to disturbances. With the rounded wall, the fluid can penetrate into the swirl channels substantially without any disturbance and without head losses resulting from the change in direction. The fluid in the swirl channels is then accelerated, as a result of the section S1 being smaller than the section S0.

In another advantageous aspect of the invention, the core side wall is cylindrical and the core front wall is plane. Thus, the core does not have any particular orientation, and the nozzle may be engaged around the core without determining its orientation. Easier mounting is thus obtained.

The present invention thus defines a spray head having a configuration that is very particular and that finds an advantageous use with shear thinning fluids that, by way of example, contain xanthan gum at a content of about 1% or less.

The spirit of the invention resides in the fact that the fluid that flows through the nozzle is subjected to as little variation in head loss as possible, so as to avoid absorbing too much energy that would then cause too much expansion that would disturb the formation of droplets causing them to tend to join together so as to form a jet. This applies in particular to shear thinning fluids, but also to fluids of other types. The ratio of the sections (or the diameters) of the dispenser orifice and of the swirl chamber and/or the length of the swirl channels relative to the diameter of the swirl chamber constitute characteristics that can be considered as having a direct influence on forming a spray of good quality. Naturally, the other characteristics of the nozzle also make it possible to further improve the quality of the spray.

The invention is described below in greater detail with reference to the accompanying drawings, which show two embodiments of the invention as non-limiting examples.

### IN THE FIGURES

FIG. 1 is a vertical section view through a dispenser head constituting a first embodiment of the invention;

FIG. 2 is a larger-scale view of a portion of FIG. 1;

FIG. 3 is an even larger-scale view of the nozzle in FIGS. 1 and 2;

FIG. 4 is a rear view in perspective showing the inside of the FIG. 3 nozzle.

FIG. 5 shows the fluid flow passage inside the nozzle;

FIGS. 6a and 6b are transparent views of the fluid flow passage in FIG. 5, as seen from two different angles of view; and

FIG. 7 is a view similar to the view in FIG. 3 for a second embodiment of the invention.

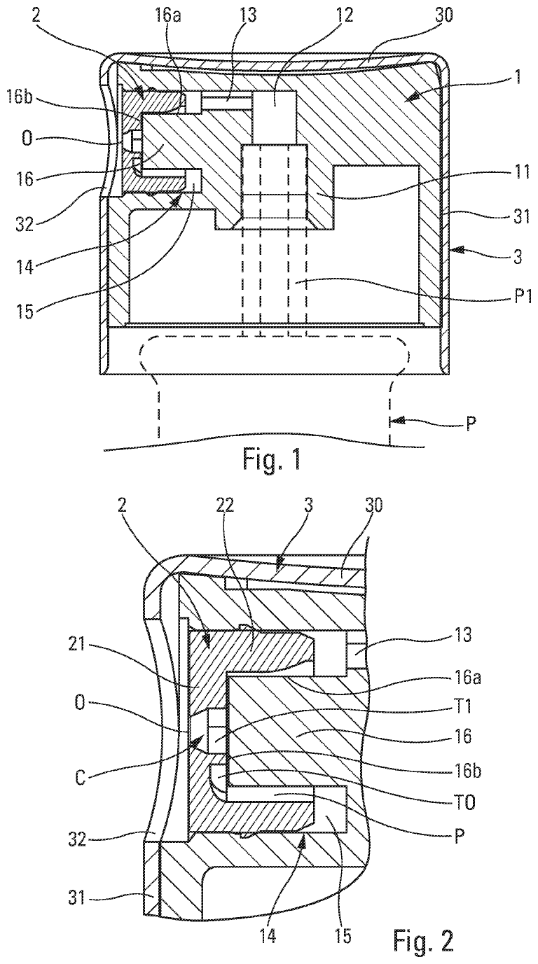

Reference is made firstly to FIGS. 1 and 2 in order to describe the general structure of a fluid spray head constituting a first embodiment of the invention. In FIG. 1, it can be seen that the dispenser head comprises a head body 1 that forms a connection sleeve 11 in which there is engaged the free end of a valve rod P1 of a dispenser unit P that may be a pump or a valve. Preferably, it is a standard pump that delivers fluid through its valve rod P1 with a pressure lying in the range about 3 bars to 6 bars. Above the connection sleeve 11, the body 1 forms an axial space 12 that extends substantially in line with the valve rod P1. The body 1 then forms a feed duct 13 that extends horizontally, i.e. perpendicularly to the connection sleeve 11. The feed duct 13 opens out into an annular housing 14 in which there extends a core 16 that defines a core side wall 16a and a core front wall 16b. The housing 14 opens out sideways into the body 1. This design is entirely conventional for a head body in the fields of cosmetics, perfumery, and pharmacy.

The head also includes a nozzle 2 that is force-fitted in the housing 14 around the core 16. The nozzle 2 presents the general shape of a cup with a dispenser wall 21 into which a spray orifice O opens out. The dispenser wall 21 comes into abutting contact with the core front wall 16b. The nozzle 2 also includes a side fastener wall 22 that is engaged around the core 16. Thus, in the housing 14 there exists an annular space 15 that is situated between the outlet of the feed channel 13 and the free end edge of the side fastener wall 22. The side fastener wall 22 may also form one or more barbs 23 for fastening the nozzle in the housing 14.

Upstream from the dispenser orifice O, the dispenser wall 21 forms a swirl chamber C that is fed by a plurality of swirl channels T that are themselves fed by a plurality of connection passages P, all formed between the core 16 and the nozzle 2. The connection passages P are fed by the annular space 15. This design is entirely conventional for a nozzle in the fields of perfumery, cosmetics, and pharmacy.

The spray head also includes a covering hoop 3 that is in the form of a cap in which the core 1 is engaged. The covering hoop 3 includes a side skirt 31 that is perforated with a window 32 facing the dispenser wall 21 of the nozzle 2. The top wall 30 of the covering hoop 3 forms a bearing surface for a user's finger. Once again, this design is entirely conventional for a covering hoop in the fields of perfumery, cosmetics, and pharmacy.

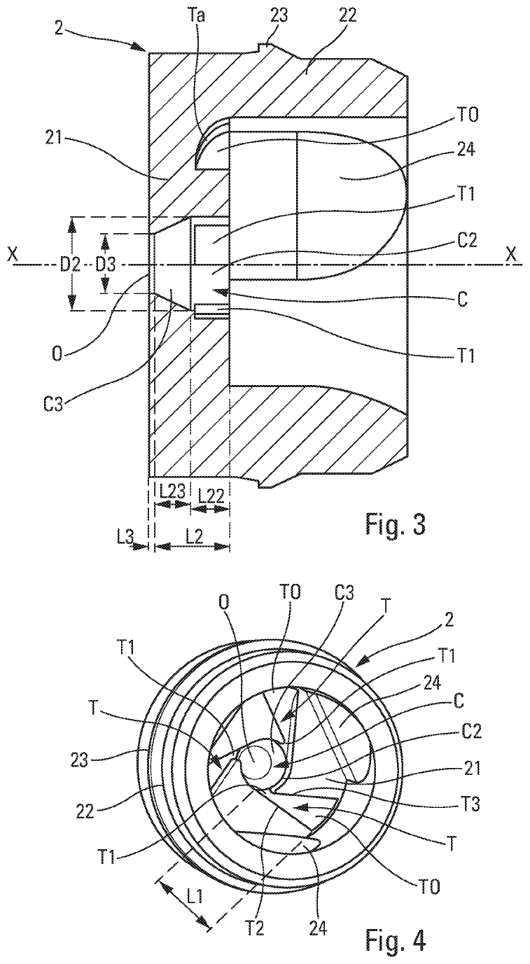

Reference is made below to FIGS. 3 and 4 in order to describe in detail the small features of the nozzle 2. The dispenser orifice O presents a chamber outlet diameter D3 that defines a chamber outlet section S3, and an axial length or depth L3 that is measured along the axis X in FIG. 3.

The swirl chamber C is centered on the dispenser orifice O along the longitudinal axis of revolution X. The swirl chamber C presents a maximum chamber inlet diameter D2 that defines a maximum chamber inlet section S2. The outlet of the chamber is formed by the dispenser orifice O, such that the minimum chamber outlet diameter is equal to D3. In greater detail, it can be seen that the swirl chamber C comprises a cylindrical portion C2 having a diameter that is D2, and a frustoconical portion C3 that is arranged between the cylindrical portion C2 and the dispenser orifice O, such that the maximum diameter of the cylindrical portion C3 is equal to D2 and its minimum diameter is equal to D3. The axial length or depth of the cylindrical portion C2 is L22, and the axial length or depth of the frustoconical portion C3 is L23. It can thus be said that L2=L22+L23.

In addition, in FIG. 4, it can be seen that the nozzle 2 includes three swirl channels T that present configurations that are generally triangular. The three swirl channels T are arranged uniformly around the swirl chamber C. Each swirl channel T includes a channel inlet T0 that defines a channel inlet section S0, and a channel outlet T1 that defines a channel outlet section S1. Each swirl channel T also defines a length L1, as can be seen in FIG. 4. Each swirl channel T includes two walls T2 and T3 that extend in a manner that is substantially tangential to the swirl chamber C. As a result, the two walls T2 and T3 are not parallel but, on the contrary, they converge towards the swirl chamber, where they form between them the channel outlet T1 of section S1. Consequently, S0 is greater than S1. The other two walls (not referenced) of the swirl channel T are identical, parallel, and formed respectively by the front wall 16b of the core 16 and by the dispenser wall 21.

It should also be observed that the inside of the side fastener wall 22 forms three reinforcements 24 that are arranged between the three channel inlets T0. The function of the three reinforcements 24 is to come into contact with the side wall 16a of the core 16. Between the reinforcements 24, the nozzle 2 co-operates with the core 16 to form the three connection passages P. The connection passages P are in fluid flow communication with the channel inlets T0. To this end, it can be observed that the channel inlets T0 include a rounded wall Ta, so that the fluid passing through the connection passages P is deflected in progressive manner along the rounded walls Ta into the respective swirl channels T. The rounded walls Ta thus form gentle ramps that connect each connection passage P to a respective swirl channel T. They make it possible to pass smoothly from an axial orientation (the orientation of the connection passages P) to a radial orientation (the orientation of the swirl channels).

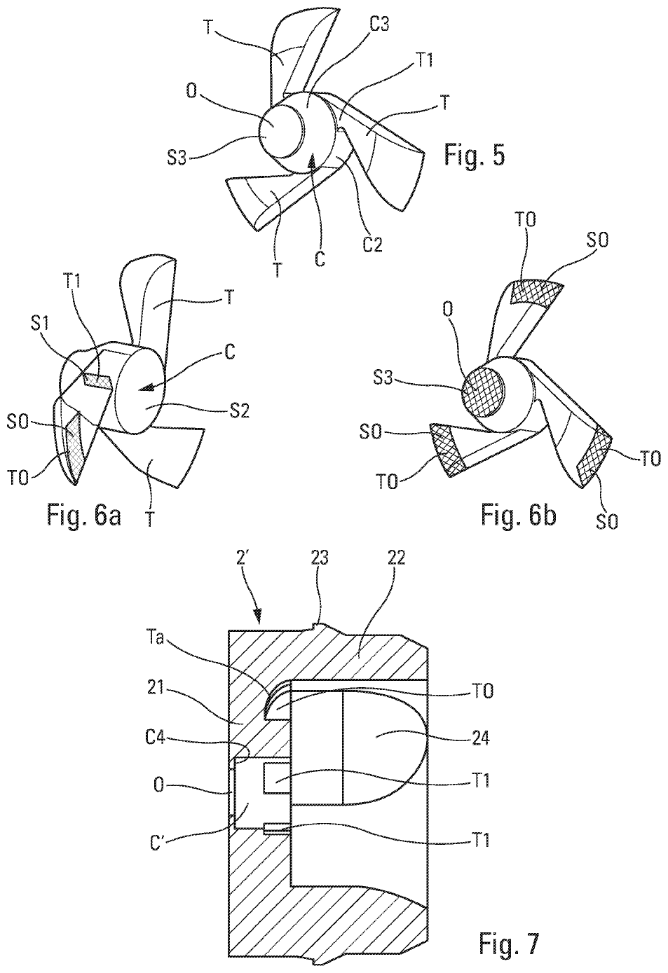

The sections S0, S1, S2, and S3 can be seen more clearly in FIGS. 5, 6a, and 6b, which show fluid flow passages, i.e. the volume that the fluid occupies between the core 16 and the nozzle 2. In other words, the fluid flow passage corresponds to the volumes of the swirl channels, of the swirl chamber, and of the dispenser orifice O.

The sections S2 and S3 extend perpendicularly to the axis X, and are arranged in parallel manner at each axial end of the swirl chamber C. The outlet sections S1 of the channels extend parallel to the axis X in a manner that is substantially tangential to the swirl chamber C.

Finally, the inlet sections S0 extend parallel to the sections S2 and S3, but off-center relative to the swirl chamber C. It can even be said that the section S0 extends in the same plane as the section S2, given that they are defined at the front wall 16b of the core 16. It can also be said that the sections S0 and S1 extend in respective planes that are arranged perpendicularly relative to each other.

The various lengths, sections, and diameters are defined below:
S0: section of the inlet T0 of the swirl channel T;

S1: section of the outlet T1 of the swirl channel T;
S2: inlet section of the swirl chamber C;
S3: section of the dispenser orifice O corresponding to the outlet section of the swirl chamber C;
D2: inlet diameter of the swirl chamber C;
D3: diameter of the dispenser orifice O corresponding to the outlet diameter of the swirl chamber C;
L1: length of the swirl channel T;
L2: length of the swirl chamber C;
L22: length of the cylindrical portion C2 of the swirl chamber C;
L23: length of the frustoconical portion C3 of the swirl chamber C; and
L3: length of the dispenser orifice O.

The term “section” should be understood as the maximum section, the term “diameter” should be understood as the maximum diameter, and the term “length” should be understood as the maximum length. The term “approximately” means ±5% when referring to a percentage, and ±10% when referring to a magnitude.

In the invention, the various lengths, sections, and diameters satisfy the following relationships R1 to R8:
R1: 30% of S2≤S3≤55% of S2, and preferably S3 is equal to approximately 42% of S2, which in terms of diameter corresponds to: 54% of D2≤D3≤74% of D2, and preferably D3 is equal to approximately 65% of D2;
R2: L1≥110% of D2, and preferably L1 is equal to approximately 150% of D2;
R3: S1≤50% of S0, and preferably S1=33% of S0;
R4: L2≥80% of D2;
R5: 30% of D2≤L23≤60% of D2, and preferably L23 is equal to approximately half of D2;
R6: 30% of D2≤L22≤50% of D2, and preferably L22 is equal to approximately 40% of D2;
R7: L3<30% de D3; and
R8: S1≤10% de S2.

In order to obtain a spray of good quality, it turns out that the relationships R1 and R2, considered in isolation or in combination, are often the most important, but without neglecting the other relationships, which also have an effect on the quality of the spray. In some circumstances, R1 has more influence than R2, and in other circumstances, the opposite applies, and in certain configurations R1 and R2 are equally influential.

The relationship R3 turns out to be the third most influential relationship in most circumstances. Combining the relationships R1+R3 or R2+R3 may thus also be considered as being particularly influential on the quality of the spray.

In certain configurations, the same applies for R4, such that combining the relationships R1+R4 or R2+R4 may thus also be considered as being particularly influential on the quality of the spray.

The relationships R5 and R6 correspond to a preferred embodiment that gives the best results in terms of quality of the spray. However, it is possible to make a swirl chamber C′ without any frustoconical portion, as can be seen in FIG. 7. The swirl chamber C′ is then connected to the dispenser orifice via a shoulder C4.

The relationship R7 implies that L3 may be zero, such that the dispenser orifice O may be formed by an annular edge.

In certain configurations, it cannot be excluded that one or another of the relationships R1 to R9 turns out to be the most influential or important, such that protection could be sought for each of the nine relationships taken individually.

A nozzle that is particularly suitable for spraying a fluid containing approximately 0.5% of xanthan gum or gel has been made with the following dimensions (with a tolerance of 10%):
S0=0.21 mm²;
S1=0.07 mm²;
S2=0.785 mm², i.e. D2=1 mm;
S3=0.33 mm², i.e. D3=0.65 mm;
L1=1.46 mm;
L2=0.88 mm;
L22=0.38 mm;
L23=0.5 mm; and
L3=0.025 mm.

These values also take into account the standard dimensions for the housing 14 and the core 16 of a conventional head in perfumery and cosmetics, which dimensions are generally about 4.5 mm in diameter for the housing and 2.8 mm for the core.

Several versions of nozzle were tested in order to determine the ranges of values for S0, S1, S2, S3, L1, L2, L22, L23, and L3 that make it possible to obtain a spray of acceptable quality. The results were as follows:
0.15 mm²≤S0≤0.28 mm²;
0.05 mm²≤S1≤0.1 mm²;
0.5 mm²≤S2≤1.13 mm², such that 0.8 mm≤D2≤1.2 mm;
0.2 mm²≤S3≤0.38 mm², such that 0.5 mm≤D3≤0.7 mm;
1.1 mm≤L1≤2.2 mm;
0.7 mm≤L2≤1.1 mm;
0.3 mm≤L22≤0.5 mm;
0.3 mm≤L23≤0.6 mm; and
0 mm≤L3≤0.3 mm.

With regard more particularly to D2 and D3, the following D2/D3 ratios were tested: 1/0.4-1/0.5-1/0.6-1/0.65-1/0.7. The best spray was obtained with D2/D3=1/0.65. The ratio 1/0.4 was found to be insufficient and the ratios 1/0.5, 1/0.6, and 1/0.7 were found to be satisfactory.

Several lengths L2 lying in the range 0.4 mm to 1 mm were also tested with D2=1 mm: when L2<0.8 mm, the spray degraded. The optimum value was 0.88 mm.

It is clear that it is not possible to determine in general and universal manner which of the characteristics S0, S1, S2 (D2), S3 (D3), L1, L2, L22, L23, and L3 and/or which of the relationships R1 to R8 is/are essential relative to the others, and this in any situation, circumstance, or configuration, and whatever the type of fluid. Nevertheless, with a shear thinning fluid containing xanthan gum for example, at a content of less than 1%, and preferably less than 0.5%, the influence of S2/S3 and/or L1/S2 are often found to be decisive.

1. A fluid spray head comprising:
a body forming a connection sleeve that is adapted to receive a valve rod of a dispenser member, such as a pump or a valve, the connection sleeve being connected, via a feed duct, to a housing in which there extends a core that defines a core side wall and a core front wall;
a nozzle engaged in the housing around the core, the nozzle forming a spray orifice through which the fluid leaves the spray head in the form of a spray, the spray orifice presenting a chamber outlet diameter D3 and a chamber outlet section S3;
the core and the nozzle defining between them, from upstream to downstream:
a plurality of connection passages in fluid communication with the feed duct;
a plurality of swirl channels respectively connected to the connection passages, each swirl channel presenting a channel length L1, a channel inlet having a channel inlet section S0, and a channel outlet having a channel outlet section; and
a swirl chamber into which the swirl channels open out, the swirl chamber defining a longitudinal axis of revolution X and presenting an axial length L2, a chamber inlet diameter D2, and a chamber inlet section S2 where the swirl channels open out, the dispenser orifice-EQ forming an outlet for the swirl chamber;
the spray head being characterized in that:
30% of S2≤S3≤55% of S2, and preferably S3 is equal to approximately 42% of S2, such that 54% of D2≤D3≤74% of D2, and preferably D3 is equal to approximately 65% of D2; and
L1≥110% of D2, and preferably L1 is equal to approximately 150% of D2.

2. A spray head according to claim 1, wherein 0.5 mm²≤S2≤1.13 mm², and preferably S2 is equal to approximately 0.785 mm², such that 0.8 mm≤D2≤1.2 mm, and preferably D2 is equal to approximately 1 mm.

3. A spray head according to claim 1 wherein 0.2 mm²≤S3≤0.38 mm², and preferably S3 is equal to approximately 0.33 mm², such that 0.5 mm≤D3≤0.7 mm, and preferably D3 is equal to approximately 0.65 mm.

4. A spray head according to claim 1 wherein L1≥1.1 mm, and preferably L1 is equal to approximately 1.5 mm.

5. A spray head according to claim 1 wherein the dispenser orifice is cylindrical and presents an axial length L3 that is less than approximately 30% of D3.

6. A spray head according to claim 1 wherein L2≥80% of D2, and preferably L2 is equal to approximately 0.88 mm.

7. A spray head according to claim 1, wherein the swirl chamber includes a frustoconical portion having a maximum diameter that is equal to D2 and that presents an axial length L23 that lies in the range 30% to 60% of D2, and preferably is approximately half of D2.

8. A spray head according to claim 7, wherein the swirl chamber also includes a cylindrical portion into which the swirl channels open out, the cylindrical portion presenting an axial length L22 that is equal to approximately 40% of D2.

9. A spray head according to claim 1 wherein S1≤50% of S0, and preferably S1=33% of S0.

10. A spray head according to claim 1 wherein S1 is equal to approximately 0.07 mm² and S0 is equal to approximately 0.21 mm².

11. A spray head according to claim 1 wherein S1≤10% of S2.

12. A spray head according to claim 1, wherein the channel inlet forms a rounded wall, so that the fluid passing through the connection passages is deflected in progressive manner along the rounded walls into the respective swirl channels.

13. A spray head according to claim 1 wherein the core side wall is cylindrical and the core front wall is plane.

14. A method of applying fluid, comprising spraying a shear thinning fluid using the spray of claim 1.

15. The method of claim 14, wherein the fluid contains xanthan gum.
